(19) United States
(12) Patent Application Publication
(10) Pub. No.: US 2026/0092583 A1
(43) Pub. Date: Apr. 2, 2026

(54) HYDROGEN ENGINE

(71) Applicant: TOYOTA JIDOSHA KABUSHIKI KAISHA, Toyota-shi (JP)

(72) Inventors: Mina KAWAI TACHIBANA, Toyota-shi (JP); Tomihisa Tsuchiya, Toyota-shi (JP)

(73) Assignee: TOYOTA JIDOSHA KABUSHIKI KAISHA, Toyota-shi (JP)

(21) Appl. No.: 19/221,946

(22) Filed: May 29, 2025

(30) Foreign Application Priority Data
Oct. 2, 2024 (JP) 2024-173796

(51) Int. Cl. F02M 21/02

(52) U.S. Cl. CPC F02M 21/0281; F02M 21/0206

(57) ABSTRACT

A hydrogen engine includes: a combustion chamber that combusts an air-fuel mixture of air and a hydrogen gas; an injector that directly injects the hydrogen gas into the combustion chamber; and an insertion hole which communicates with the combustion chamber and into which the injector is inserted. A film of a lubricant containing a composition having a molecular structure having no alkyl group in a side chain is provided on a surface of the injector in the insertion hole.

### CROSS-REFERENCE TO RELATED APPLICATION

This application claims priority to Japanese Patent Application No. 2024-173796 filed on Oct. 2, 2024. The disclosure of the above-identified application, including the specification, drawings, and claims, is incorporated by reference herein in its entirety.

### BACKGROUND

### 1. Technical Field

The present disclosure relates to a hydrogen engine.

### 2. Description of Related Art

Japanese Unexamined Patent Application Publication No. 2024-76203 (JP 2024-76203 A), for example, describes a liquid hydrogen system that supplies hydrogen to a hydrogen engine.

### SUMMARY

An in-cylinder direct injection injector injects a hydrogen gas directly into a combustion chamber of a hydrogen engine. The direct injection injector is inserted into an insertion hole provided in a cylinder head of the hydrogen engine. When the hydrogen engine is manufactured, a lubricant (insertion aid) is applied to the surface of the insertion site of the direct injection injector so as to facilitate insertion.

However, there are types of lubricants having high ignitability with high oxidation reactivity in an environment of an air-fuel mixture of a hydrogen gas and air. When such a type of lubricant is used, there is a possibility that the lubricant ignites each time the hydrogen gas is injected from the direct injection injector, causing abnormal combustion such as pre-ignition.

The present disclosure has been made in view of the above issue, and has an object to provide a hydrogen engine capable of suppressing abnormal combustion of a hydrogen gas.

An aspect of the present disclosure provides a hydrogen engine including:
a combustion chamber that combusts an air-fuel mixture of air and a hydrogen gas;
an injector that directly injects the hydrogen gas into the combustion chamber; and
an insertion hole which communicates with the combustion chamber and into which the injector is inserted, in which
a film of a lubricant containing a composition having a molecular structure having no alkyl group in a side chain is provided on a surface of the injector in the insertion hole.

In the above hydrogen engine,
the injector may include a seal member that seals a gap between an inner wall of the insertion hole and the injector; and
a film of the lubricant may be provided on a surface of the seal member.

In the above hydrogen engine,
the composition may be a polydimethylsiloxane represented by the chemical formula below. In the chemical formula below, X is an integer of 2 or more.

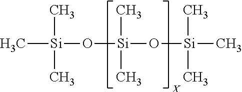

According to the present disclosure, it is possible to suppress abnormal combustion of a hydrogen gas in a hydrogen engine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a partial cross-sectional view schematically illustrating an example of a hydrogen engine;

FIG. 2 is a plan view schematically showing a bottom surface of a cylinder head; and

FIG. 3 is a partial cross-sectional view of the cylinder head taken along III-III of FIG. 2.

### DETAILED DESCRIPTION OF EMBODIMENTS

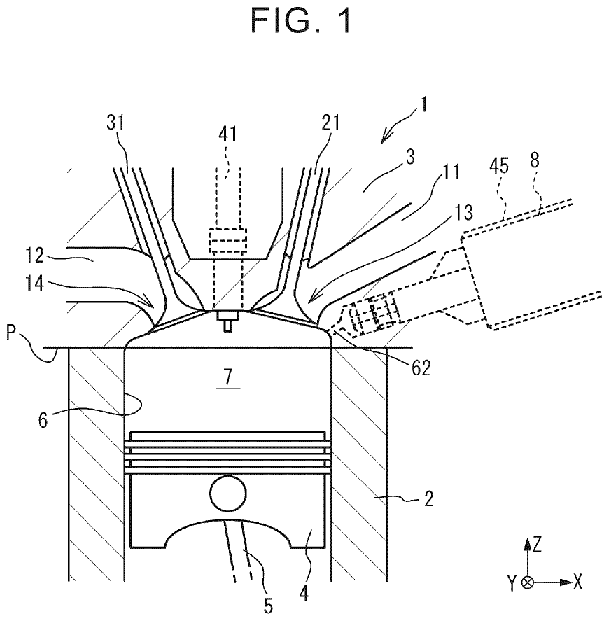

FIG. 1 is a partial cross-sectional view schematically illustrating an example of a hydrogen engine 1. The hydrogen engine 1 includes a cylinder block 2, a cylinder head 3, a piston 4, a connecting rod 5, and a direct injection injector 8. The hydrogen engine 1 is mounted as a driving source in a vehicle such as a hydrogen vehicle. In FIG. 1 to FIG. 3, the X direction, the Y direction, and the Z direction orthogonal to each other are illustrated.

The cylinder head 3 is joined to the cylinder block 2 at an interface P along X-Y plane. A cylinder 6 along the Z direction is provided inside the cylinder block 2. The cylinder head 3 is arranged to close one open end of the cylinder 6. The cylinder block 2 and the cylinder head 3 are formed of a metal such as an aluminum alloy or cast iron.

The piston 4 reciprocates in the Z direction in the cylinder 6. The piston 4 is connected to the connecting rod 5 via a piston pin. The connecting rod 5 is connected to a crankshaft (not shown) via a crankpin. The connecting rod 5 serves to convert the reciprocating movement of the piston 4 into a rotational movement of the crankshaft. The wall surface of the cylinder 6 of the cylinder block 2, the cylinder head 3, and the upper surface of the piston 4 define a combustion chamber 7 in which an air-fuel mixture of air and hydrogen gas is combusted.

The cylinder head 3 is provided with an intake port 11 for intake and an exhaust port 12 for exhaust so as to be adjacent to each other in the X direction. The intake port 11 faces the combustion chamber 7 and communicates with the combustion chamber 7 via an intake opening 13 formed in the cylinder head 3. The exhaust port 12 faces the combustion chamber 7 and communicates with the combustion chamber 7 via an exhaust opening 14 formed in the cylinder head 3. Further, the cylinder head 3 is provided with an intake valve 21 for opening and closing the intake opening 13, an exhaust valve 31 for opening and closing the exhaust opening 14, a spark plug 41 for igniting the air-fuel mixture in the combustion chamber 7, and an injector 8 for directly injecting hydrogen gas into the combustion chamber 7.

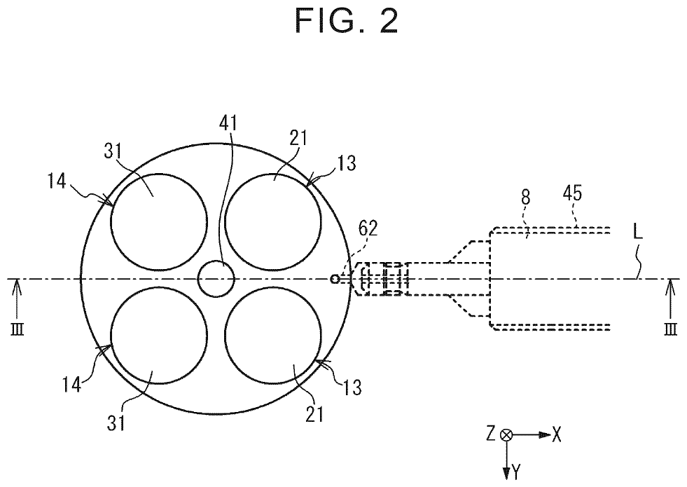

FIG. 2 is a plan view schematically showing a bottom surface of the cylinder head 3. The combustion chamber 7 is provided with two sets of intake openings 13 and exhaust openings 14. The two intake openings 13 are arranged side by side in the Y direction, and the two exhaust openings 14 are also arranged side by side in the Y direction. The spark plug 41 is arranged along the Z direction and is located substantially at the center of the two intake openings 13 and the two exhaust openings 14. The injector 8 is inserted into the insertion hole 45 in the cylinder head 3, and injects hydrogen gas into the combustion chamber 7 through the injection hole 62 opened in the combustion chamber 7. The injector 8 is arranged such that its axis L passes along the X-direction between the two intake openings 13 in the Y-direction and between the two exhaust openings 14.

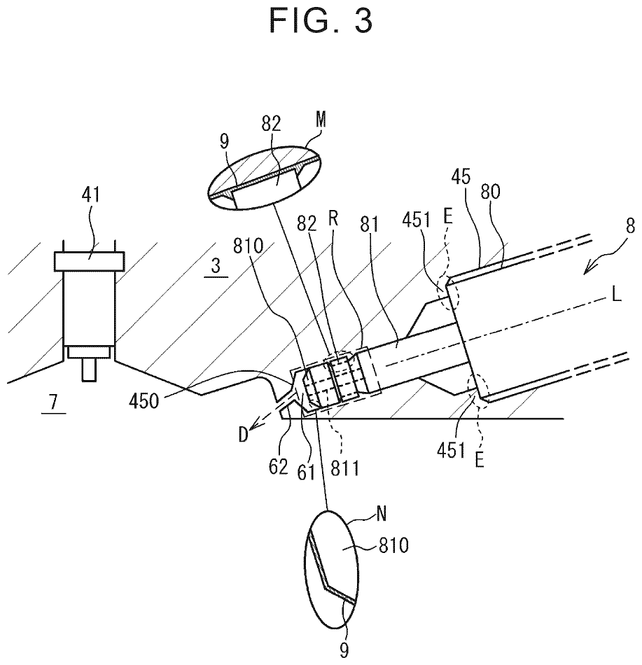

FIG. 3 is a partial cross-sectional view of the cylinder head 3 along III-III of FIG. 2. The injector 8 is inserted into an insertion hole 45 in the cylinder head 3. The insertion hole 45 extends toward substantially the center of the combustion chamber 7 and is formed in accordance with the shape of the injector 8. The insertion hole 45 communicates with the combustion chamber 7 through the injection hole 62.

The injector 8 has a substantially cylindrical main body portion 80, an extending portion 81 extending from the main body portion 80, and a distal end portion 810 provided at the distal end of the extending portion 81. The extending portion 81 has a substantially columnar shape having a diameter smaller than that of the main body portion 80 and a constricted portion, and a substantially band-shaped seal member 82 is wound around the constricted portion. The seal member 82 is formed of, for example, Teflon (registered trademark), and seals a gap between the seal member and the inner wall of the insertion hole 45. This maintains the airtightness of the combustion chamber 7. Note that if the airtightness of the combustion chamber 7 is maintained, the seal member 82 is not necessarily provided.

The distal end portion 810 has a tapered annular shape facing the injection direction of the hydrogen gas, and faces the inner wall 450 on the side of the combustion chamber 7 adjacent to the edge of the opening of the injection hole 62 in the insertion hole 45. A gap 61 called a sack or the like is formed between the distal end portion 810 and the inner wall 450. Inside the distal end portion 810 and the extending portion 81, a delivery hole 811 through which hydrogen gas is delivered is provided along the axis L direction. Hydrogen gas enters the gap 61 from the delivery hole 811 and is injected into the combustion chamber 7 through the injection hole 62 as indicated by an arrow D. The direction in which the injection hole 62 extends is inclined by a predetermined angle with respect to the axis L of the injector 8 so that the hydrogen gas is injected in an appropriate direction inside the combustion chamber 7.

The distal end portion 810 of the injector 8 is separated from the combustion chamber 7 by a gap 61 between it and the inner wall 450 of the insertion hole 45. As a result, the temperature rise of the needle (not shown) or the like of the injector 8 is suppressed as compared with the case where the gap 61 is not present. When the temperature resistance of the injector 8 is high, the gap 61 may not be provided.

As indicated by reference numeral E, the insertion hole 45 has a stepped portion 451 formed so as to be in contact with the front end side surface of the main body portion 80. When the main body portion 80 and the stepped portion 451 come into contact with each other, the injector 8 is positioned with respect to the insertion hole 45.

The injector 8 is inserted into the insertion hole 45 when the hydrogen engine 1 is manufactured. At this time, a lubricant that functions as an insertion aid is applied to the surface of the injector 8 in a range indicated by reference numeral R so as to facilitate insertion. The lubricant is applied to the surface of the distal end portion 810 and the extending portion 81 and the outer surface of the seal member 82. The lubricant remains applied to the surface of the injector 8 even after the injector 8 is inserted into the insertion hole 45. On the other hand, if a port injection type injector is used, it is not necessary to insert the injector into the insertion hole 45 such as the injector 8, and it is attached to the intake port 11 of the cylinder head 3.

Reference numeral M denotes a schematic view in which the vicinity of the seal member 82 is enlarged. A thin film of lubricant 9 is present between the surface of the extending portion 81 and the seal member 82 and the inner peripheral surface of the insertion hole 45. As described above, since the lubricant is applied not only to the surface of the extending portion 81 but also to the outer peripheral surface of the seal member 82, the friction between the portion covered with the seal member 82 and the inner peripheral surface of the insertion hole 45 in the extending portion 81 is reduced when the injector 8 is inserted, thereby facilitating the insertion.

In addition, reference numeral N denotes a schematic view in which the vicinity of the distal end portion 810 is enlarged. Between the surface of the distal end portion 810 and the inner peripheral surface of the insertion hole 45, there is a thin film 9 of lubricant. As described above, since the lubricant is also applied to the distal end portion 810, even if the distal end portion 810 and the inner peripheral surface of the insertion hole 45 come into contact with each other at the time of insertion of the injector 8, friction between the distal end portion and the inner peripheral surface is reduced, thereby facilitating insertion. It should be noted that the thin film 9 is not necessarily formed continuously as indicated by the reference M, N, but may be formed separately at a plurality of locations. The thin film 9 of lubricant is an example of a lubricant film.

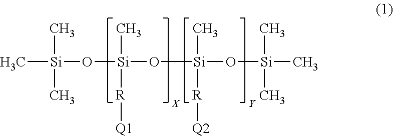

Formula (1) shows the molecular structure of the composition contained in the lubricant of the comparative example. In formula (1), X and Y are the number of iterations of the concept in parentheses and are integers greater than or equal to 2. R represents an organic group such as an aryl group, Q1 represents an alkyl group, and Q2 represents an aralkyl group. The lubricant is alkyl aralkyl modified silicone oil. In the molecular structure of the lubricant, three methyl groups (—CH₃) and silicon atoms (Si) bonded to oxygen atoms (O) are bonded to other silicon atoms in the repeating structure (X) via oxygen atoms. The silicon atoms in the repeating structure are bonded to methyl, oxygen, and alkyl groups.

The silicon atom in the repeating structure is bonded to the silicon atom of another repeating structure (Y) through an oxygen atom. Silicon atoms in another repeating structure are bonded to methyl, oxygen, and aralkyl groups. This silicon atom is bonded via an oxygen atom to another silicon atom which is bonded to three methyl groups (—CH₃).

Lubricants are polymers with a silicon-oxygen (Si—O) backbone, in which Si—O bonds are stabilized by the bonding of the methyl-group to the silicon atoms. The molecular weight of the silicone oil is relatively higher than that of other types of oils, and the volatility of the silicone oil is low due to the strong intermolecular force. Silicone oil is stable over a wide temperature range, is resistant to heat, has excellent heat resistance, and is capable of suppressing decomposition and volatilization even in a high-temperature environment. Methyl groups are also less flammable than the hydrocarbon chains of normal carbon-carbon bonds.

The oxidation reaction of the alkyl group is exothermic and releases a lot of energy. Therefore, the lubricant of the comparative example can serve as an ignition source that causes an oxidation exothermic reaction in an environment of an air-fuel mixture of hydrogen gas and air. The minimum ignition energy of hydrogen-gas is 0.02 mJ, while the minimum ignition energy of methane, for example, is 0.28 mJ. Therefore, when the hydrogen gas is injected from the injector 8, the lubricant applied around the injector 8 may ignite due to an oxidation exothermic reaction, causing abnormal combustion such as pre-ignition. In particular, since the lubricant applied to the surface of the distal end portion 810 is exposed to the hydrogen gas existing in the gap 61 between the inner wall 450 of the insertion hole 45, it is likely to be an ignition source.

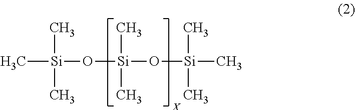

Formula (2) shows the molecular structure of the composition contained in the lubricant of the examples. Here, the composition includes polydimethylsiloxane. In formula (2), X is the number of iterations of the concept in parentheses and is an integer greater than or equal to 2. The example lubricant is silicone oil. In the molecular structure of the lubricant, three methyl groups (—CH₃) and silicon atoms (Si) bonded to oxygen atoms (O) are bonded to other silicon atoms in the repeating structure (X) via oxygen atoms. The silicon atoms in the repeating structure are bonded to two methyl and oxygen atoms. This silicon atom is bonded via an oxygen atom to another silicon atom which is bonded to three methyl groups (—CH₃).

As in the comparative example, Si—O bond of the lubricant of the example is stabilized by bonding the methyl-group to the silicon-atom. Further, since the lubricant of the embodiment is silicone oil, decomposition and volatilization are suppressed even in a high-temperature environment as described above, and there is also an advantage that the methyl group is not easily burned.

The lubricants of the examples do not have an alkyl group in the side chain of their molecular structure. The lubricant of the example is less likely to undergo an exothermic oxidation reaction in an environment of an air-fuel mixture of hydrogen gas and air than a lubricant having an alkyl group in a side chain as in the comparative example. Therefore, even if the lubricant of the embodiment is applied to the surface of the injector 8, when the hydrogen gas is injected from the injector 8, the possibility of causing abnormal combustion such as pre-ignition is reduced as compared with the comparative example. As an example of the lubricant, a silicone oil is exemplified, but the present disclosure is not limited thereto, and a fluorine-based oil or a hydrocarbon-based oil may be used. Here, since the viscosity change with respect to the temperature change is generally smaller than that of other types of oil, the fluorine oil exhibits high stability under a severe environment in which the temperature change is large.

As described above, in the hydrogen engine 1 of the present embodiment, since the lubricant having the molecular structure having no alkyl group in the side chain is applied to the surface of the injector 8, abnormal combustion of the hydrogen gas can be suppressed.

The above-described embodiments are preferred embodiments of the present disclosure. However, the present disclosure is not limited thereto, and various modifications can be made without departing from the gist of the present disclosure.

What is claimed is:

1. A hydrogen engine comprising:
a combustion chamber that combusts an air-fuel mixture of air and a hydrogen gas;
an injector that directly injects the hydrogen gas into the combustion chamber; and
an insertion hole which communicates with the combustion chamber and into which the injector is inserted, wherein
a film of a lubricant containing a composition having a molecular structure having no alkyl group in a side chain is provided on a surface of the injector in the insertion hole.

2. The hydrogen engine according to claim 1, wherein:
the injector includes a seal member that seals a gap between an inner wall of the insertion hole and the injector; and
a film of the lubricant is provided on a surface of the seal member.

3. The hydrogen engine according to claim 1, wherein the composition is a polydimethylsiloxane represented by the chemical formula below, where X is an integer of 2 or more [chemical structure]
